(19) United States
(12) Patent Application Publication
(10) Pub. No.: US 2011/0127689 A1
(43) Pub. Date: Jun. 2, 2011

(54) APPARATUS FOR MANUFACTURING ELECTRONIC COMPONENT AND METHOD FOR MANUFACTURING ELECTRONIC COMPONENT

(75) Inventors: Jae Kwang KIM, Suwon (KR); Chang Sub Song, Hwaseong (KR); Jun Suk Jung, Suwon (KR)

(73) Assignee: SAMSUNG ELECTRO-MECHANICS CO., LTD.

(21) Appl. No.: 12/768,480

(22) Filed: Apr. 27, 2010

(30) Foreign Application Priority Data
Dec. 1, 2009 (KR) 10-2009-0117644

(51) Int. Cl. B29C 45/14; B28B 7/36

(52) U.S. Cl. 264/101; 425/89

(57) ABSTRACT

An apparatus for manufacturing an electronic component includes: upper and lower metal molds, at least one of which being formed as a porous member on which an electronic component is mounted, including an internal space for accommodating the electronic component therein; a release film providing unit providing a release film to the internal space of the upper and lower metal molds; and a molding resin providing unit providing a molding resin to the internal space to allow the electronic component to be injection-molded.

### CROSS-REFERENCE TO RELATED APPLICATIONS

This application claims the priority of Korean Patent Application No. 10-2009-0117644 filed on Dec. 1, 2009, in the Korean Intellectual Property Office, the disclosure of which is incorporated herein by reference.

### BACKGROUND OF THE INVENTION

1. Field of the Invention

The present invention relates to an apparatus for manufacturing an electronic component capable of injection-molding an electronic component fixedly adsorbed on a porous member, and a method for manufacturing an electronic component.

2. Description of the Related Art

In general, electron components such as a semiconductor chip, a solid condenser, and the like, which are to be mounted on the surface of a semiconductor substrate, are injection-molded.

An electronic component manufacturing apparatus that injection-molds relevant electronic components includes a manufacturing mold having an upper metal mold and a lower metal mold and a release film providing unit for providing a release film to the manufacturing mold.

Here, an electronic component is mounted on the upper metal mold, and a cavity filled with a molding resin is formed on the lower metal mold.

The upper metal mold includes a vacuum suction hole connected with a vacuum suction unit to allow the electronic component to be mounted thereon.

Also, in order to prevent the molding resin from clinging to the manufacturing mold, a release film is mounted within the cavity. In order to mount the release film within the cavity, a vacuum suction hole connected with the vacuum suction unit is formed at the lower metal mold.

The electronic component manufacturing apparatus, however, has a problem in that the external appearance of the electronic component cannot be maintained to be flat due to the pressure that sucks air in the cavity.

Also, the electronic component is injection-molded in a state that the release film is placed on the vacuum suction hole, resulting in deformation of the external appearance of the electronic component.

In addition, because the vacuum suction hole needs to be processed in the manufacturing mold, it is not easy to manufacture the manufacturing mold.

### SUMMARY OF THE INVENTION

An aspect of the present invention provides an apparatus for manufacturing an electronic component capable of injection-molding an electronic component which is fixedly adsorbed to a porous member, and a method for manufacturing an electronic component.

According to an aspect of the present invention, there is provided an apparatus for manufacturing an electronic component, including: upper and lower metal molds, at least one of which being formed as a porous member on which an electronic component is mounted, including an internal space for accommodating the electronic component therein; a release film providing unit providing a release film to the internal space of the upper and lower metal molds; and a molding resin providing unit providing a molding resin to the internal space to allow the electronic component to be injection-molded.

The electronic component may be mounted on one of the upper and lower metal molds, and a cavity forming the internal space may be formed on the other of the upper and lower metal molds.

One of the upper and lower metal molds may include a porous member, and the release film may be sucked by the other of the upper and lower metal molds so as to be mounted on the cavity.

The electronic component may be mounted by the medium of a mount frame on one of the upper and lower metal molds.

The electronic component may be a tantalum condenser where the mount frame and a lead frame are in contact.

The release film providing unit may include a release film providing roller and a release film winding roller, and the release film may be transported according to the driving of at least one of the release film providing roller and the release film wiring roller.

The release film providing unit may include a plate having an air jetting hole and a vacuum suction hole, and the release film may jet air to the air jetting hole to provide the same to the internal space.

According to another aspect of the present invention, there is provided an apparatus for manufacturing an electronic component, including: upper and lower metal molds having an internal space accommodating an electronic component, at least one of which having a vacuum suction hole; an adsorption plate mounted on one of the upper and lower metal molds, allowing the electronic component to be mounted thereon, and including a porous member; a release film providing unit providing a release film to the internal space of the upper and lower metal molds; and a molding resin providing unit providing a molding resin to the internal space to allow the electronic component to be injection-molded.

A cavity forming the internal space may be formed on the other of the upper and lower metal molds.

One of the upper and lower metal molds may include a porous member, and the release film may be sucked by the other of the upper and lower metal molds so as to be mounted on the cavity.

The other of the upper and lower metal molds may have a vacuum suction hole sucking the release film, and the other of the upper and lower metal molds, on which the release film is in contact, may include a porous adsorption plate.

A gas connection gap may be formed between the other of the upper and lower metal molds and the porous adsorption plate.

The electronic component may be mounted by the medium of a mount frame on the adsorption plate.

The electronic component may be a tantalum condenser where the mount frame and a lead frame are in contact.

A gas connection gap may be formed between one of the upper and lower metal molds and the adsorption plate.

The release film providing unit may include a release film providing roller and a release film winding roller, and the release film may be transported according to the driving of at least one of the release film providing roller and the release film wiring roller.

The release film providing unit may include a plate having an air jetting hole and a vacuum suction hole, and the release film may jet air to the air jetting hole to provide the same to the internal space.

According to another aspect of the present invention, there is provided a method for manufacturing an electronic component, including: providing upper and lower metal molds, at least one of which being formed as a porous member; disposing an electronic component such that it is adsorbed to the porous member; providing a release film to between the upper and lower metal molds; providing the release film to the other of the upper and lower metal molds having a cavity; disposing the release film such that it is in contact with the cavity; and inputting a molding resin to the interior of the cavity and assembling the metal molds to injection-mold the electronic component.

One of the upper and lower metal molds may include the porous member.

The porous member may be mounted on one of the upper and lower metal molds.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic sectional view of an apparatus for manufacturing an electronic component according to one exemplary embodiment of the present invention;

FIG. 2 is an enlarged view of A in FIG. 1;

FIG. 3 is a schematic sectional view showing a state in which a release film is adsorbed to a cavity;

FIG. 4 is a schematic sectional view showing providing of a molding resin to the cavity;

FIG. 5 is a schematic sectional view showing that upper and lower films are assembled to injection-mold an electronic component;

FIG. 6 is a schematic sectional view of an upper metal mold of an apparatus for manufacturing an electronic component according to another exemplary embodiment of the present invention;

FIG. 7 is a schematic sectional view of a lower metal mold of an apparatus for manufacturing an electronic component according to another exemplary embodiment of the present invention; and

FIG. 8 is a schematic sectional view of a release film providing unit according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

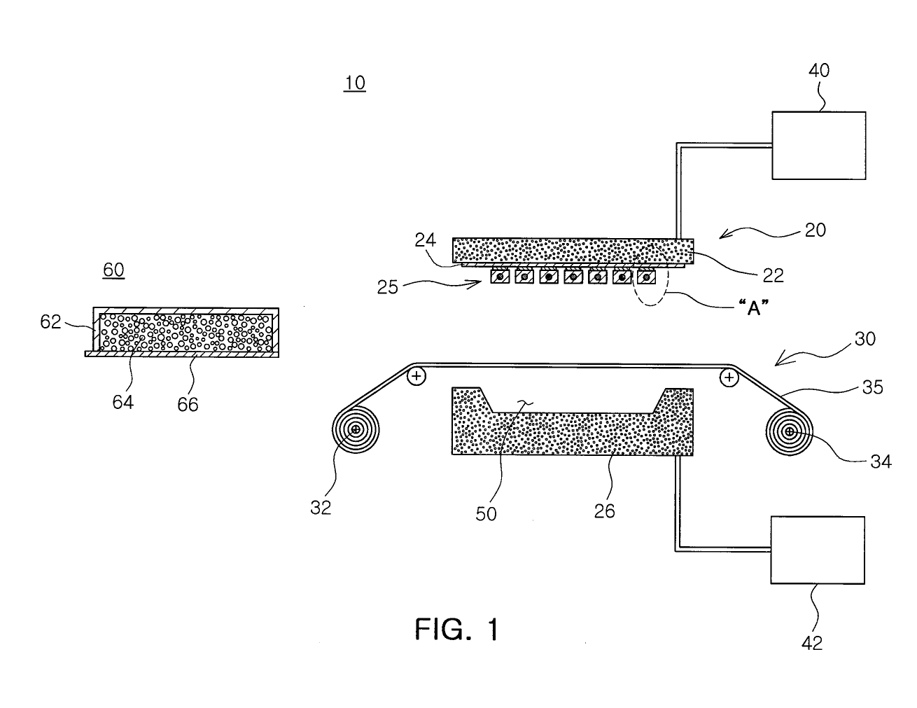

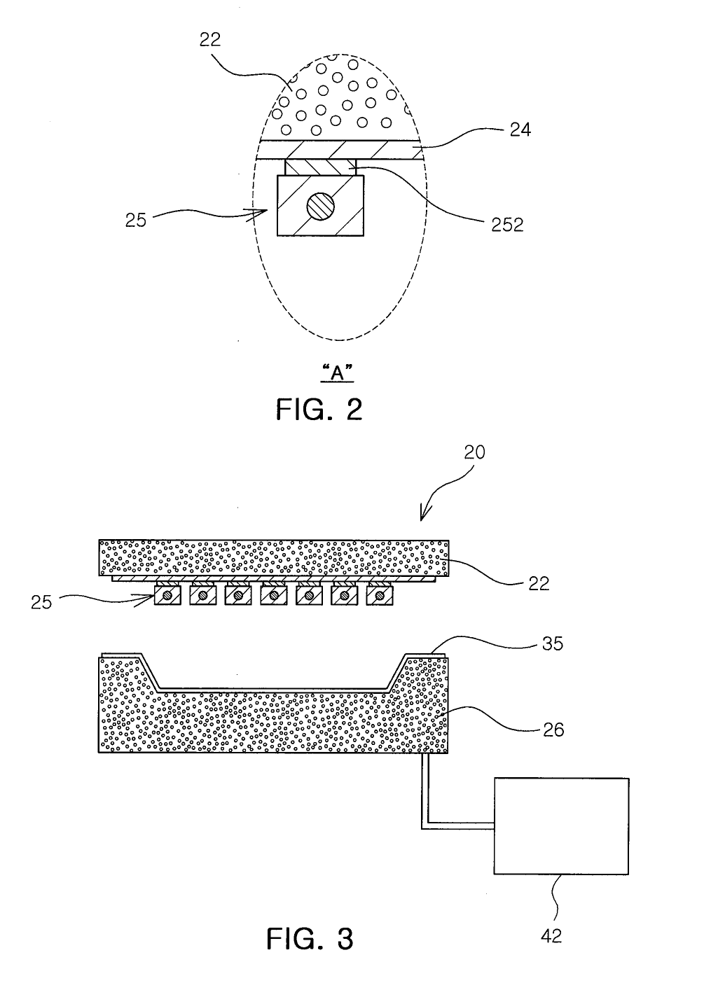

FIG. 1 is a schematic sectional view of an apparatus for manufacturing an electronic component according to one exemplary embodiment of the present invention, and FIG. 2 is an enlarged view of ‘A’ in FIG. 1.

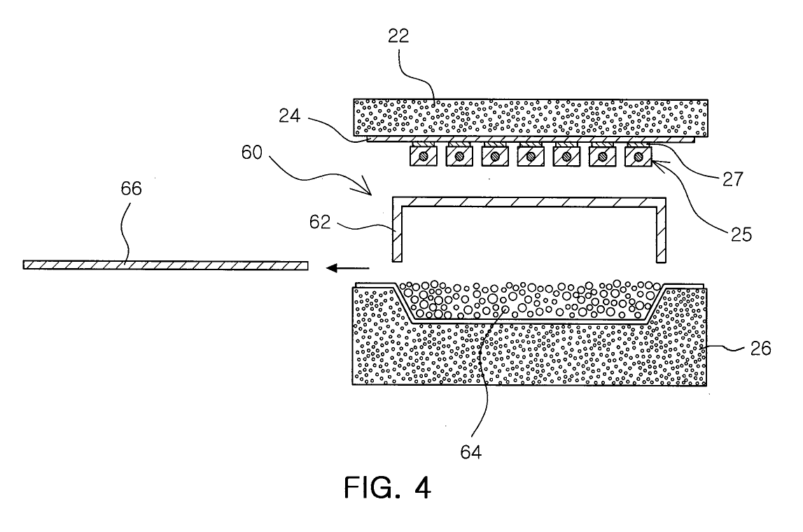

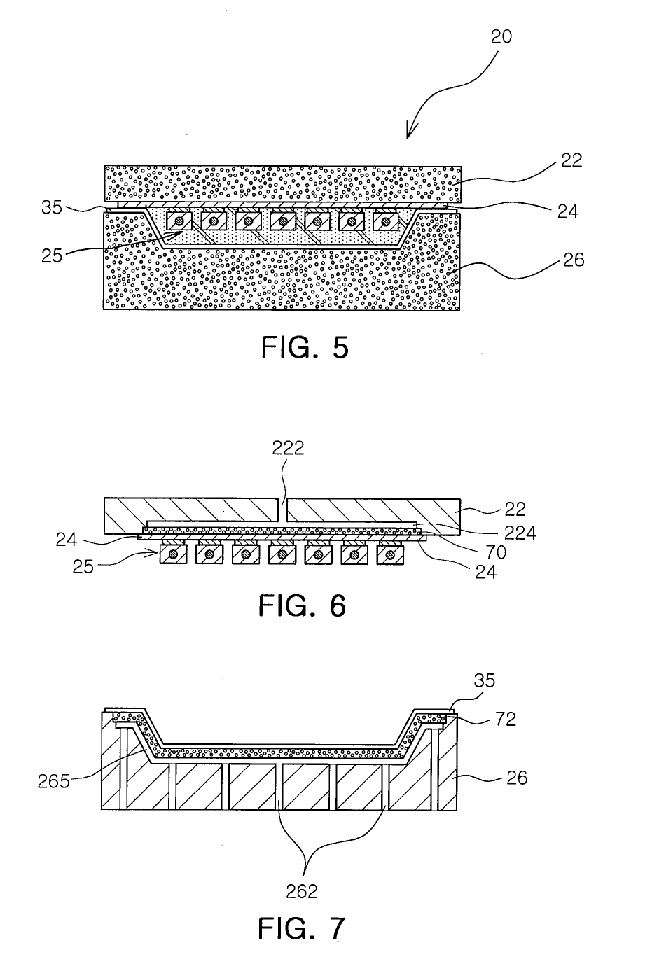

FIG. 3 is a schematic sectional view showing a state in which a release film is adsorbed to a cavity, FIG. 4 is a schematic sectional view showing providing of a molding resin to the cavity, and FIG. 5 is a schematic sectional view showing that upper and lower films are assembled to injection-mold an electronic component.

With reference to FIGS. 1 to 5, an apparatus for manufacturing an electronic component 10 according to the present exemplary embodiment may include: a manufacturing mold 20 including upper and lower molds 22 and 26, a release film providing unit 30, and a molding resin providing unit 60.

An electronic component 25 is mounted on at least one of the upper and lower metal molds, and a cavity 50 may be formed on the other of the upper and lower metal molds to form an internal space of the manufacturing mold 20.

In the present exemplary embodiment, the electronic component 25 is mounted on the upper metal mold 22, and the cavity 50 is formed on the lower metal mold 26.

The upper metal mold 22 is formed as a porous member and connected with a vacuum suction unit 40. The electronic component 25 is adsorbed on the upper metal mold 22 as the vacuum suction unit 40 is driven. The number of electronic components 25 may be selected as necessary.

Here, the electronic component 25 may be mounted on the upper metal mold 22 by the medium of a mount frame 24. The mount frame 24 may be formed as a thin sheet such as a film and serve to prevent a lead frame 252 for surface-mounting of the electronic component 25 from being directly in contact with the metal mold and contaminated. The mount frame 24 may be formed of a polyimide film having resistance to a high temperature and high pressure. The mount frame 24 may be bonded on the upper metal mold 22 by means of an adhesive.

The lower metal mold 26 may be also formed as a porous member and connected with a vacuum suction unit 42 in order to adsorb a release film 35. The vacuum suction unit 42 serves to allow the release film 35 to be adsorbed on the surface of the cavity 50 of the lower metal mold 26.

Because the upper metal mold 22 and the lower metal mold 26 are formed as porous members, a suction pressure can be uniform to thus prevent deformation of the electronic component 25 and the release film 35. Also, the porous members serve to allow the lead frame 252 of the electronic component 25 to be maintained as flat without being deformed.

The electronic component 25 may be any electronic component so long as its external appearance is formed through molding, and it may be a tantalum condenser surface-mounted with the lead frame 252.

Here, the porous members may be made of a ceramic material capable of enduring a high temperature and high pressure, the requirements for molding.

The molding resin providing unit 60 provides a molding resin into the cavity 50 so that the electronic component 25 can be injection-molded. The molding resin providing unit 60 may include a case 62 and a cover 64 covering the case 62. The molding resin within the case 62 may be a liquid type resin or a powder type resin. Largely, the molding resin within the case 62 may be epoxy mold compound (EMC).

The release film providing unit 30 may include a release film providing roller 32 and a release film winding roller 34. The release film 35 may be transported according to the driving of at least one of the release film providing roller 32 and the release film winding roller 34.

The release film providing unit 30 is disposed such that the release film 35 is transported on and along the lower metal mold 26, and the release film 35 may be mounted on the cavity 50 of the lower metal mold 26 according to the driving of the vacuum suction u nit 42 connected with the lower metal mold 26.

A method for manufacturing an electronic component injection-molded by using the electronic component manufacturing apparatus 10 as described above will now be described.

First, as shown in FIG. 1, the upper and lower metal molds 22 and 26, at least one of which is formed as a porous member, are provided. The electronic component 25 is then disposed on the upper metal mold 22 formed as a porous member and fixedly adsorbed thereon.

Next, as shown in FIG. 3, the release film 35 is adsorbed on the cavity 50 of the lower metal mold 26 by using the vacuum suction unit 42.

And then, as shown in FIG. 4, a molding resin is input to the interior of the cavity 50. Subsequently, as shown in FIG. 5, the upper and lower metal molds are assembled to injection-mold an electronic component at a high temperature and in a high pressure state.

Thereafter, the upper and lower metal molds 22 and 26 are separated and dicing is performed so as to manufacture the electronic component 25.

Here, the porous member may be formed as a component separated from the upper metal mold 22, and may adsorb the electronic component 25 in a state of being fixed on the upper metal mold 22.

FIG. 6 is a schematic sectional view of an upper metal mold of an apparatus for manufacturing an electronic component according to another exemplary embodiment of the present invention.

With reference to FIG. 6, the upper metal mold 22 is not formed as a porous member but formed as a general metal mold having a vacuum suction hole 222. In FIG. 6, a single vacuum suction hole 222 is illustrated, but the present invention is not limited thereto and a plurality of vacuum suction holes may be formed according to a selection by a person having skill in the art.

An adsorption plate 70 may be mounted at an inner side of the upper metal 22, and the electronic component 25 may be adsorbed on the adsorption plate 70.

In the exemplary embodiment illustrated in FIG. 6, the electronic component may be mounted on the adsorption plate 70 by the medium of the mount frame 24.

Here, a gas connection gap 224 may be formed between the upper metal mold 22 and the adsorption plate 70 to allow a uniform suction pressure to be applied to the porous adsorption plate 70.

Other elements constituting the electronic component manufacturing apparatus are the same as those described above with reference to FIGS. 1 to 5, so a description thereof will be omitted.

FIG. 7 is a schematic sectional view of a lower metal mold of an apparatus for manufacturing an electronic component according to another exemplary embodiment of the present invention.

With reference to FIG. 7, the lower metal mold 26 according to the present exemplary embodiment is not formed as a porous member but formed as a general metal mold having vacuum suction holes 262. The number of the vacuum suction holes 262 may be determined according to a selection by person having skill in the art.

The part to which the release film 35 is to be adsorbed includes a porous adsorption plate 72 in order to suck the release film 35 with a uniform pressure. Here, a gas connection gap 265 may be formed between the lower metal mold 26 and the porous adsorption plate 72.

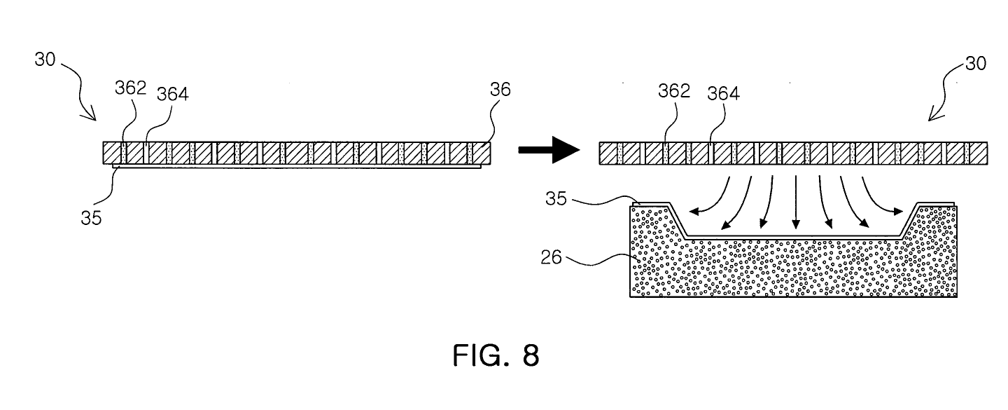

FIG. 8 is a schematic sectional view of a release film providing unit according to another exemplary embodiment of the present invention.

The release film providing unit 30 according to the present exemplary embodiment employs a plate 36 transportation method, rather than employing the method of transporting the release film by a roller, in order to provide the release film 35 to a metal mold.

The plate 36 may include vacuum suction holes 362 to allow the release film 35 to be adsorbed on the plate 35. Also, after the release film 35 is transported to the lower metal mold 26, air is jetted to the release film 35 through air jetting holes 364 to allow the release film 35 to be tightly attached to the lower metal mold 26.

As set forth above, in the apparatus for manufacturing an electronic component and the method for manufacturing an electronic component according to exemplary embodiments of the invention, because the manufacturing mold is fabricated as a porous member, an electronic component or a release film can be adsorbed with a uniform pressure.

Also, because the manufacturing mold does not have a vacuum suction hole, the surface of the electronic component, in particular, in case where the electronic component sucked to the manufacturing mold is a lead frame, the lead frame can be maintained as flat.

While the present invention has been shown and described in connection with the exemplary embodiments, it will be apparent to those skilled in the art that modifications and variations can be made without departing from the spirit and scope of the invention as defined by the appended claims.

1. An apparatus for manufacturing an electronic component, the apparatus comprising:
upper and lower metal molds, at least one of which being formed as a porous member on which an electronic component is mounted, comprising an internal space for accommodating the electronic component therein;
a release film providing unit providing a release film to the internal space of the upper and lower metal molds; and
a molding resin providing unit providing a molding resin to the internal space to allow the electronic component to be injection-molded.

2. The apparatus of claim 1, wherein the electronic component is mounted on one of the upper and lower metal molds, and a cavity forming the internal space is formed on the other of the upper and lower metal molds.

3. The apparatus of claim 2, wherein one of the upper and lower metal molds comprises a porous member, and the release film is sucked by the other of the upper and lower metal molds so as to be mounted on the cavity.

4. The apparatus of claim 1, wherein the electronic component is mounted by the medium of a mount frame on one of the upper and lower metal molds.

5. The apparatus of claim 4, wherein the electronic component is a tantalum condenser where the mount frame and a lead frame are in contact.

6. The apparatus of claim 1 the release film providing unit comprises a release film providing roller and a release film winding roller, and the release film is transported according to the driving of at least one of the release film providing roller and the release film wiring roller.

7. The apparatus of claim 1, wherein the release film providing unit comprises a plate having an air jetting hole and a vacuum suction hole, and the release film jets air to the air jetting hole to provide the same to the internal space.

8. An apparatus for manufacturing an electronic component, the apparatus comprising:
upper and lower metal molds having an internal space accommodating an electronic component, at least one of which having a vacuum suction hole;
an adsorption plate mounted on one of the upper and lower metal molds, allowing the electronic component to be mounted thereon, and comprising a porous member;
a release film providing unit providing a release film to the internal space of the upper and lower metal molds; and
a molding resin providing unit providing a molding resin to the internal space to allow the electronic component to be injection-molded.

9. The apparatus of claim 8, wherein a cavity forming the internal space is formed on the other of the upper and lower metal molds.

10. The apparatus of claim 9, wherein one of the upper and lower metal molds comprises a porous member, and the release film is sucked by the other of the upper and lower metal molds so as to be mounted on the cavity.

11. The apparatus of claim 9, wherein the other of the upper and lower metal molds comprises a vacuum suction hole sucking the release film, and the other of the upper and lower metal molds, on which the release film is in contact, comprises a porous adsorption plate.

12. The apparatus of claim 11, wherein a gas connection gap is formed between the other of the upper and lower metal molds and the porous adsorption plate.

13. The apparatus of claim 8, wherein the electronic component is mounted by the medium of a mount frame on the adsorption plate.

14. The apparatus of claim 13, wherein the electronic component is a tantalum condenser where the mount frame and a lead frame are in contact.

15. The apparatus of claim 8, wherein a gas connection gap is formed between one of the upper and lower metal molds and the adsorption plate.

16. The apparatus of claim 8, wherein the release film providing unit comprises a release film providing roller and a release film winding roller, and the release film is transported according to the driving of at least one of the release film providing roller and the release film wiring roller.

17. The apparatus of claim 8, wherein the release film providing unit comprises a plate having an air jetting hole and a vacuum suction hole, and the release film jets air to the air jetting hole to provide the same to the internal space.

18. A method for manufacturing an electronic component, the method comprising:
providing upper and lower metal molds, at least one of which comprising a porous member;
disposing an electronic component such that it is adsorbed to the porous member;
providing a release film to between the upper and lower metal molds;
providing the release film to the other of the upper and lower metal molds having a cavity;
disposing the release film such that it is in contact with the cavity; and
inputting a molding resin to the interior of the cavity and assembling the metal molds to injection-mold the electronic component.

19. The method of claim 18, wherein one of the upper and lower metal molds comprises the porous member.

20. The method of claim 18, wherein the porous member is mounted on one of the upper and lower metal molds.
